(19) United States
(12) Patent Application Publication
(10) Pub. No.: US 2025/0332928 A1
(43) Pub. Date: Oct. 30, 2025

(54) BATTERY UNIT

(71) Applicant: MAZDA MOTOR CORPORATION, Hiroshima (JP)

(72) Inventors: Yoshikazu NISHIMURA, Hiroshima (JP); Taiki YOTSUYANAGI, Hiroshima (JP); Tatsuya ISHIKAWA, Hiroshima (JP); Masayuki MIYAZAKI, Hiroshima (JP)

(73) Assignee: MAZDA MOTOR CORPORATION, Hiroshima (JP)

(21) Appl. No.: 19/171,387

(22) Filed: Apr. 7, 2025

(30) Foreign Application Priority Data
Apr. 26, 2024 (JP) 2024-072758

(51) Int. Cl. B60L 50/64; B60K 1/04; B60L 50/60; B62D 21/15; B62D 25/02; H01M 50/204; H01M 50/242; H01M 50/249; H01M 50/271

(52) U.S. Cl. CPC B60L 50/64; B60K 1/04; B60L 50/66; B62D 21/157; B62D 25/025; H01M 50/204; H01M 50/242; H01M 50/249; H01M 50/271; B60K 2001/0438; H01M 2220/20

(57) ABSTRACT

A battery unit including a battery cell in a battery case, wherein the battery case includes a battery frame including a frame member and a reinforcement member, the frame member including first and second frame members surrounding the battery cell, the frame and reinforcement member are hollow and have a specific cross-sectional shape, the frame member is joined to the reinforcement member, each second frame member includes a first stage reinforcement wall partitioning an inside of the second frame member, the reinforcement member includes a second stage reinforcement partitioning an inside of the reinforcement member, thickness centers of the first stage reinforcement wall part and the second stage reinforcement wall part are offset in the up-down direction, and an upper or lower surface of the second stage reinforcement wall part is between upper and lower surfaces of the first stage reinforcement wall part in the up-down direction.

### CROSS-REFERENCE TO RELATED APPLICATION

The present application claims priority to Japanese Patent Application 2024-072758, filed Apr. 26, 2024, the entire contents of which are incorporated herein by reference.

### FIELD

The disclosed technology relates to a battery unit provided below a floor panel of a vehicle with battery cells housed in a battery case.

### DESCRIPTION OF THE RELATED ART

A battery unit of this type is disclosed in Patent Literature 1.

A battery frame disclosed in Patent Literature 1 includes an outer frame having a quadrangular shape and surrounding a plurality of batteries arranged in the longitudinal direction and the lateral direction, and a bottom plate covering the lower side of these batteries. As reinforcement members, a plurality of beam members are installed between a pair of lateral frame members of the outer frame.

Even in the case in which a collision load acts on the outer frame from the lateral side, if such a load can be appropriately transmitted to the plurality of beam members extending in the direction in which the load acts, the load can be received by these beam members. Accordingly, inward deformation of the outer frame can be suppressed and the batteries can be effectively protected.

### CITATION LIST

### Patent Literature

[Patent Literature 1] Japanese Patent Laid-Open No. 9-118136

### BACKGROUND

As in the case of a collision with a pole, there may be cases in which a load acts on the outer frame at a connecting part between the beam members in a pinpoint manner. In such a case, a so-called three-point bending state will be caused because both sides of the connecting part are firmly supported by the beam members. Therefore, there is a possibility that the load cannot be appropriately transmitted to the beam members and the load is concentrated in a portion at which the load acts to cause the outer frame to be significantly deformed inward, interfering with the battery.

As a countermeasure against such a situation, reinforcing the beam members, which are reinforcement members, by increasing the number or the size of beam members can be considered. However, in such a case, new issues could occur, such as a decrease in the inner volume of the battery frame, an increase in the costs of members, and an increase in the weight of the battery frame.

In view of the above, this Description discloses a technology that can, with a simple configuration, appropriately transmit a load from a frame member to reinforcement members, and that can help suppress interference of the frame member with a battery even in the case in which the load acts on a connecting part of the frame member in a concentrated manner.

### SUMMARY

The disclosed technology relates to a battery unit disposed below a floor panel of a vehicle with a battery cell housed in a battery case.

The battery case includes a battery frame including a frame member and a reinforcement member, the frame member being formed into a rectangular shape to be adjacent to and to surround the battery cell, the reinforcement member being installed between a pair of second frame members of the frame member and in parallel with a pair of first frame members of the frame member, the pair of first frame members facing each other, the pair of second frame members facing each other, and a bottom and a lid which are assembled to the battery frame to cover an upper side and a lower side of the battery cell.

Each of the frame member and the reinforcement member is a hollow long member having a specific cross-sectional shape, and the battery frame is constituted by joining the frame member and the reinforcement member to each other with wall surfaces of the frame member and wall surfaces of the reinforcement member directed in an up-down direction and a left-right direction.

A second frame member of the pair of second frame members includes a first stage reinforcement wall part that extends in parallel with wall surfaces disposed above and below the first stage reinforcement wall part, and that partitions an inside of the second frame member in the up-down direction, and the reinforcement member includes a second stage reinforcement wall part that extends in parallel with wall surfaces disposed above and below the second stage reinforcement wall part, and that partitions an inside of the reinforcement member in the up-down direction, and a thickness center of the first stage reinforcement wall part and a thickness center of the second stage reinforcement wall part are offset from each other in the up-down direction, and an upper surface or a lower surface of the second stage reinforcement wall part is located between an upper surface and a lower surface of the first stage reinforcement wall part in the up-down direction.

That is, the disclosed technology is directed to the battery unit, as a power source for traveling, that is disposed below the floor panel of the vehicle with the battery cell housed in the battery case. The battery frame includes the frame member formed into a rectangular shape to be adjacent to and to surround the battery cell. The battery frame also includes the reinforcement member installed between the other pair of opposing frames (the pair of second frame members) of the frame member and in parallel with one pair of opposing frames (the pair of first frame members) of the frame member.

Each of the frame member and the reinforcement member is a hollow long member having a specific cross-sectional shape, and the battery frame is constituted by joining the frame member and the reinforcement member with the wall surfaces of the frame member and the wall surfaces of the reinforcement member directed in the up-down direction and the left-right direction. Since the frame member and the reinforcement member are hollow long members, the frame member and the reinforcement member have light weights, and may be excellent in strength and rigidity. In addition, the frame member and the reinforcement member respectively include the first stage reinforcement wall part and the second stage reinforcement wall part that partition the inside of the member in the up-down direction. Accordingly, strength and rigidity may be further increased.

The first stage reinforcement wall part and the second stage reinforcement wall part are offset from each other by a predetermined amount in a state of overlapping each other along the up-down direction.

The first stage reinforcement wall part and the second stage reinforcement wall part may be provided mainly to reinforce the frame member and the reinforcement member. Accordingly, to allow a load to be efficiently transmitted, the first stage reinforcement wall part and the second stage reinforcement wall part may be located at the same height and may be continuously formed in series. Some comparative battery units may have such a configuration.

Further, to appropriately transmit a load, the second stage that receives the load may have strength and rigidity that is higher (e.g., 1.2 times to 1.5 times higher) than those of the first stage that transmits the load. For this reason, the thickness of the reinforcement wall part of the second stage may be larger than that of the first stage. Further, when a member has a long length in a direction in which the load acts, the member may be easily deflected and deformed and hence such a member may have still higher strength and rigidity. Accordingly, the second stage reinforcement wall part may have higher strength and rigidity than the first stage reinforcement wall part. The reinforcement member may be more excellent in strength and rigidity than the frame member.

Therefore, in the case in which a load acts on a connecting part between two adjacent reinforcement members as in the case of a collision with a pole, a so-called three-point bending state may be caused because both sides of the connecting part may be firmly supported by the reinforcement members. Therefore, there is a possibility that the load may not be appropriately transmitted to the reinforcement member and the frame member may be significantly deformed inward, interfering with the battery cell.

In contrast, in the battery unit according to an embodiment, the first stage reinforcement wall part and the second stage reinforcement wall part may be offset from each other in a state of partially overlapping each other along the up-down direction. Therefore, of the load that acts on the first stage reinforcement wall part, a load of a predetermined proportion may be transmitted to the reinforcement member, and the remaining load may be transmitted to components other than the second stage reinforcement wall part via the frame member.

A load transmitted to the reinforcement member may be reduced and hence it is possible to help reduce strength and rigidity that could otherwise be required for the reinforcement member. It in turn allows the thickness of the second stage reinforcement wall part to be reduced. The battery unit according to an embodiment may achieve a reduction in costs of members, and a reduction in weight.

Even in the case in which a load acts on the connecting part, the reinforcement members supporting both sides of the connecting part may have a supporting force that is appropriately reduced and hence a three-point bending state can be avoided by the reinforcement members. Therefore, it is possible to suppress a situation in which the frame member is significantly deformed inward to interfere with the battery cell.

Accordingly, it is possible to effectively protect the battery cell.

The battery unit may be assembled to the vehicle with the reinforcement member being disposed to extend in a front-rear direction.

With such a configuration, it is possible to effectively protect the battery cell from a collision load from the front side or the rear side of the vehicle.

The vehicle may include a pair of front side frames that constitute a vehicle body together with the floor panel, and that extend forward from a front side of the floor panel while being spaced apart from each other in the left-right direction, and at least a portion of the second frame member that is located on a front side may be disposed at a position that overlaps with rear end parts of the pair of front side frames along the up-down direction.

From a viewpoint of protecting the battery cell, in principle it may be desirable to avoid a heavy load acting on the battery unit. However, due to the space for mounting a battery unit having a large capacity, there may be limitations on the design of the vehicle body. Therefore, there is a possibility of a decrease in the strength of the vehicle body.

In contrast, when the battery unit according to an embodiment is adopted, even in the case in which a load acts on the connecting part, it is possible to appropriately transmit the load while protecting the battery cell in the battery unit.

When a heavy collision load acts on the pair of front side frames due to a front collision or the like, the front side frames may be deformed. Then, the rear end parts of the front side frames may be displaced rearward. When the configuration described above is adopted, the rear end parts may be received by the second frame member at the time of displacement and hence, a portion of the collision load can be transmitted to the battery unit. The battery unit can complement the strength of the vehicle body.

At least a portion of a front end part of the reinforcement member may be disposed at a position that overlaps with a rear end part of a front side frame of the pair of front side frames along the left-right direction.

In the battery frame, a portion reinforced by the reinforcement member may be more excellent in strength than other portions. Accordingly, by adopting the configuration described above, it is possible to efficiently transmit a load of the front side frame to the reinforcement member.

The battery unit may be assembled to the vehicle with the reinforcement member being disposed to extend in the left-right direction.

In such a case, the vehicle may include a pair of side sills that constitute a vehicle body together with the floor panel, and that extend in a front-rear direction along both left and right side edges of the floor panel, the battery frame may further include a support part being hollow and having a rectangular cross section, the support part being integrally provided so as to project to an outer side of the frame member, and the battery case may be supported by the pair of side sills via the support part.

By disposing the reinforcement member to extend in the left-right direction, it is possible to effectively protect the battery cell from a collision load from the lateral side of the vehicle.

When the battery frame is supported by the pair of side sills via the support part integrally formed with the frame member and having a square pipe shape, a collision load from the lateral side can be directly transmitted from the side sill to the battery frame.

Further, a thickness center of at least one of an upper support wall and a lower support wall may be offset from a thickness center of the first stage reinforcement wall part in the up-down direction, the upper support wall and the lower support wall constituting the support part, and the upper surface or the lower surface of the first stage reinforcement wall part may be located between an upper surface and a lower surface of the support wall in the up-down direction.

With such a configuration, a collision load transmitted from the lateral side via the side sill can be transmitted from the support part to the second frame member, that is, to the entire battery frame, in a balanced manner while the collision load is appropriately released. The thickness of the reinforcement member of the second frame member can be reduced and hence it is possible to reduce the weight of the battery unit.

### Advantageous Effects

According to the disclosed technology, with a simple configuration for the structure of the battery unit, it is possible to appropriately transmit a load from the frame member to the reinforcement member. Even in the case in which a load acts on the connecting part of the frame member in a concentrated manner, it is possible to suppress interference of the frame member with the battery cell. Therefore, it is possible to provide a battery unit that has a light weight and that has excellent performance of protecting battery cells. The battery unit can also be assembled to a portion of a collision-load transmission mechanism of the vehicle-body structure.

### BRIEF DESCRIPTION OF THE DRAWINGS

FIG. 1 is a diagram of a vehicle-body structure to which the disclosed technology is applied, as viewed from above.

FIG. 2 is a perspective view as viewed from a direction shown by arrow A in FIG. 1.

FIG. 3 is a cross-sectional view taken along arrow line B-B in FIG. 1.

FIG. 4 is a cross-sectional view taken along arrow line D-D in FIG. 3.

FIG. 5 is a diagram as viewed from a direction shown by arrow E in FIG. 4.

FIG. 6 is a cross-sectional view taken along arrow line C-C in FIG. 1.

FIG. 7A is a diagram for illustrating the structure of a battery unit.

FIG. 7B is a diagram for illustrating the structure of the battery unit.

FIG. 8 is a diagram for illustrating the detailed structure of the battery unit related to the disclosed technology.

FIG. 9A is a diagram for illustrating a comparative example.

FIG. 9B is a diagram for illustrating the battery unit of an embodiment as a comparison with a comparative example.

FIG. 10 is a diagram for illustrating a second embodiment of the disclosed technology.

### DETAILED DESCRIPTION

Hereinafter, the disclosed technology will be described. However, this description is merely exemplary in nature. The front-rear direction, the left-right direction, and the up-down direction used in the description are determined with reference to a vehicle. In the drawings, these directions are shown by arrows. The left-right direction corresponds to a vehicle width direction.

### <Vehicle-Body Structure>

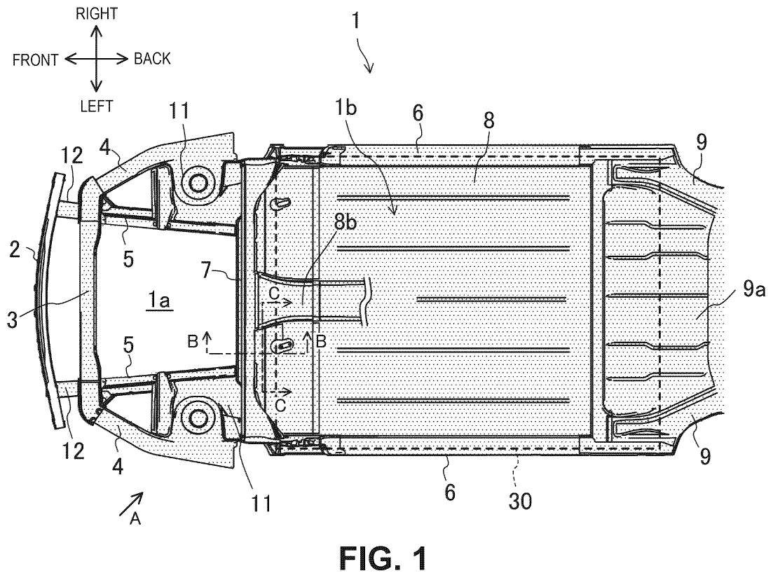

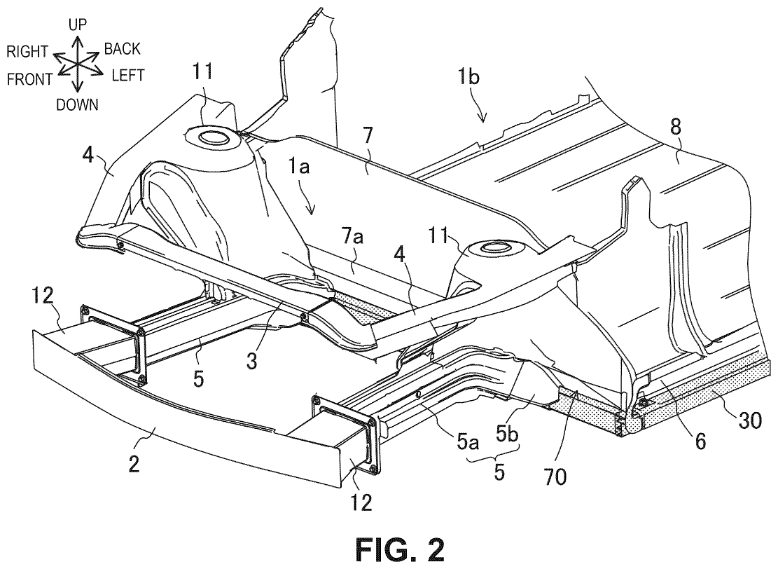

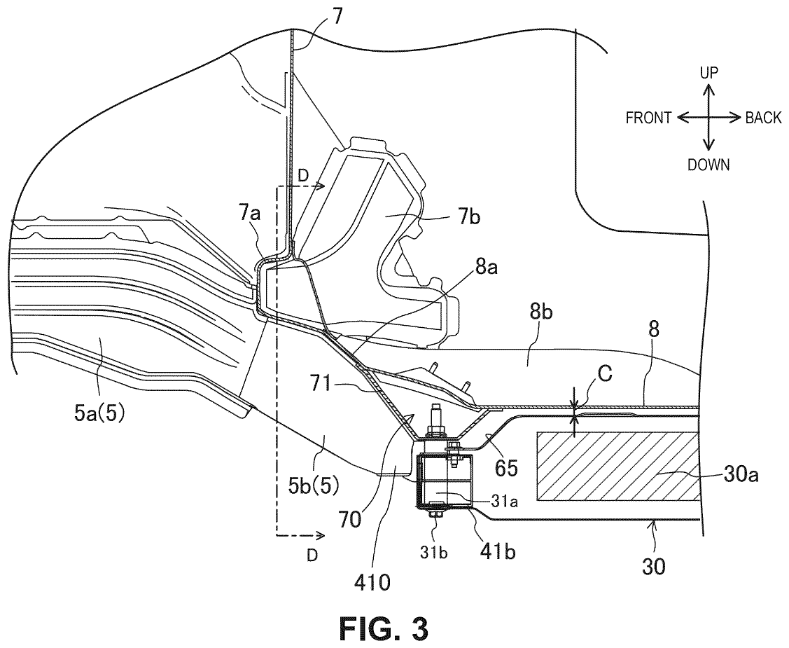

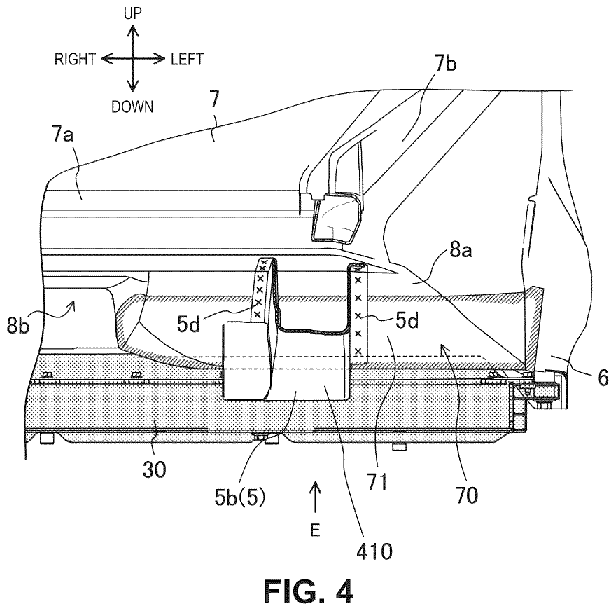

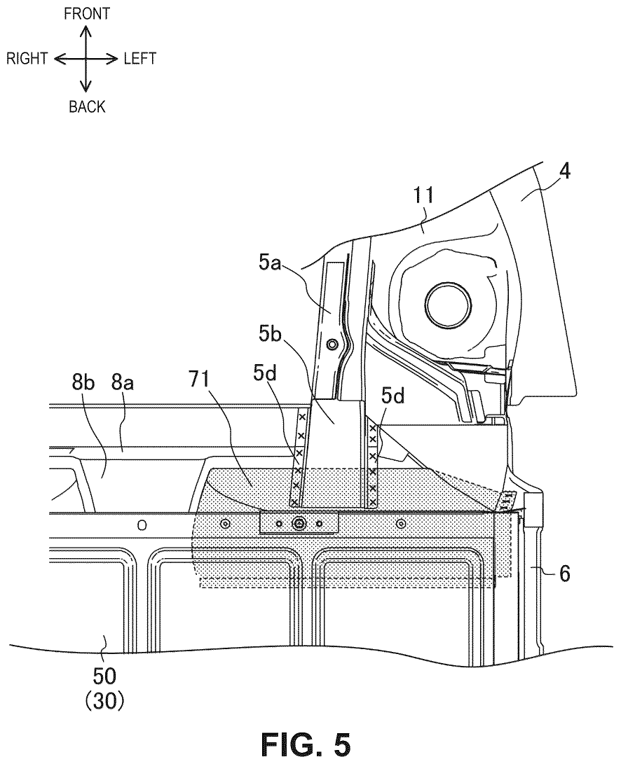

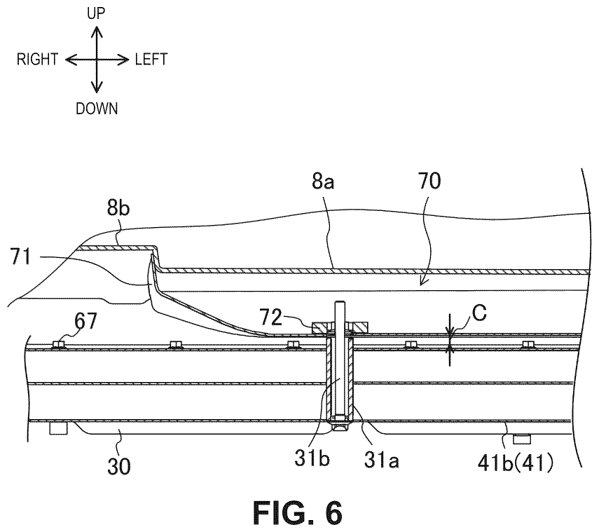

The vehicle-body structure of a vehicle to which the disclosed technology is applied is shown in FIG. 1 to FIG. 6 as an example. FIG. 1 is a diagram of a vehicle body 1 of the vehicle as viewed from above (plan view). FIG. 2 is a perspective view as viewed from a direction shown by arrow A in FIG. 1. FIG. 3 is a cross-sectional view taken along arrow line B-B in FIG. 1. FIG. 4 is a cross-sectional view taken along arrow line D-D in FIG. 3. FIG. 5 is a diagram as viewed from a direction shown by arrow E in FIG. 4 (bottom view). FIG. 6 is a cross-sectional view taken along arrow line C-C in FIG. 1. The vehicle body 1 is shown in FIG. 1 to FIG. 6 in a simplified manner.

The vehicle body 1 may be constituted of a bumper beam 2, a shroud upper member 3, apron members 4, front side frames 5, side sills 6, a dash panel 7, a floor panel 8, and the like.

This vehicle may be an electric vehicle. This vehicle may travel by driving a motor. In an implementation, the motor may be mounted in a front space 1a at the front part of the vehicle body 1. A vehicle cabin 1b may be at the intermediate part of the vehicle body 1. The floor panel 8 having a substantially rectangular shape as viewed in a top plan view may be at the intermediate part of the vehicle body 1 in such a way as to expand or extend in both the front-rear direction and the left-right direction (in the horizontal direction). The floor panel 8 constitutes the floor surface of the vehicle cabin 1b.

A battery unit 30 may be mounted in the vehicle as a power source for driving a motor for traveling. The battery unit 30 may have a high output. For this reason, the battery unit 30 may have a heavy weight and a large capacity. However, an installation space in the vehicle has limitations. Thus, as shown by a broken line in FIG. 1, the battery unit 30 may be disposed below the floor panel 8 in such a way as to expand or extend along the floor panel 8.

This battery unit 30 of the vehicle may have an external appearance substantially the same as that of the floor panel 8, the external appearance having a rectangular shape as viewed in a top plan view. The battery unit 30 will be separately described below.

As shown in FIG. 2, partitioning may be provided between the front space 1a and the vehicle cabin 1b by the dash panel 7 expanding in both the up-down direction and the left-right direction (the vertical direction). As shown in FIG. 3, an upward inclined surface part 8a may be at the front end part of the floor panel 8, the upward inclined surface part 8a being inclined upward toward the front side.

The protruding end of the upward inclined surface part 8a may be coupled to the lower end of the dash panel 7. The dash panel 7 and the floor panel 8 may be formed in an integral body by joining a plurality of steel sheets to which press working is performed. A ridge part 7a may be provided in the lower end part of the dash panel 7, the ridge part 7a extending in the left-right direction in a state of protruding forward.

A reinforcement rib 7b having a closed cross-sectional structure may be provided behind the ridge part 7a. A bulging part 8b may be formed at the center portion in the left-right direction of the front end part of the floor panel 8, the bulging part 8b extending in a band shape toward the rear side in a state of being raised and bulging upward. Torque boxes 70 may be attached to the lower surface of the floor panel 8 at positions on both left and right sides of the bulging part 8b by utilizing the upward inclined surface part 8a.

The pair of side sills 6 excellent in strength and rigidity may be provided on both left and right sides of the intermediate part of the vehicle body 1. Each side sill 6 is formed of a columnar member, and the side sills 6 extend in parallel in the front-rear direction along both left and right side edges of the floor panel 8. Rear side frames 9 extending rearward are coupled to the rear ends of the respective side sills 6. A rear floor panel 9a formed continuously with the floor panel 8 may be laid between these rear side frames 9.

As shown in FIG. 1, FIG. 2, FIG. 3 and others, a pair of front side frames 5 may extend forward from the front side of the floor panel 8 while being spaced apart from each other in the left-right direction. Each front side frame 5 may be formed of a columnar member having a rectangular cross section, and includes a main part 5a and a rear end part 5b, the main part 5a extending substantially horizontally, the rear end part 5b extending downward in an inclined manner from the rear end of the main part 5a.

Each front side frame 5 may be joined to the upward inclined surface part 8a of the floor panel 8 and to the torque box 70 via the rear end part 5b. As shown in FIG. 1 and FIG. 2, in the left-right direction, joined portions of the rear end parts 5b may be located at intermediate positions between the center and the left and right side ends of the vehicle body 1. As viewed from the up-down direction, the pair of front side frames 5 may be disposed in a slightly inclined manner such that they are farther apart from each other in the left-right direction as they go to the front side.

Suspension housings 11 may be provided in front of the left and right end parts of the dash panel 7. The lower end parts of the respective suspension housings 11 may be coupled to the respective front side frames 5. The apron members 4 are coupled to the upper end parts of the respective suspension housings 11.

Each apron member 4 may extend forward from the outer side of each suspension housing 11. Each apron member 4 may bend more inward in the vehicle width direction as it goes to the front side. The distal ends of the pair of apron members 4 may be coupled to each other by the shroud upper member 3 extending in the left-right direction.

The bumper beam 2 extending in the left-right direction may be disposed at a position lower than and in front of the shroud upper member 3. The front ends of the respective front side frames 5 may be coupled to both end parts of this bumper beam 2 via crush cans 12.

### <Battery Unit>

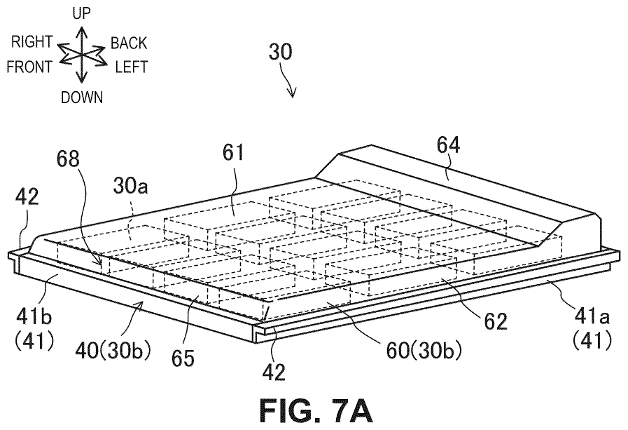

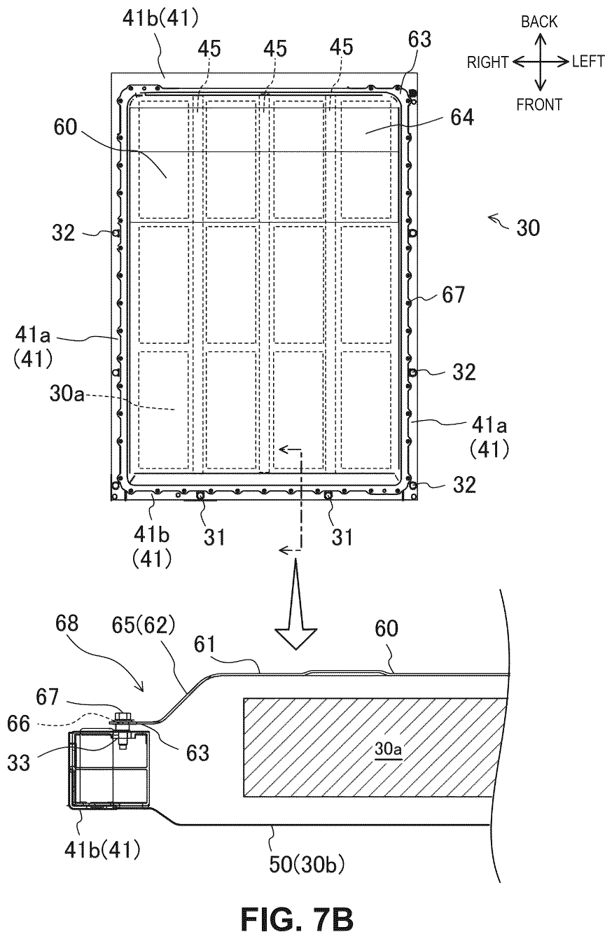

The structure of the battery unit 30 is shown in FIG. 7A and FIG. 7B as an example. The battery unit 30 may include a plurality of battery cells 30a, and a battery case 30b that houses these battery cells 30a.

The respective battery cells 30a may be constituted by connecting a large number of lithium ion batteries or the like. All the battery cells 30a may be electrically connected with each other and configured to be able to output a predetermined high voltage. By taking into account loading efficiency in the battery case 30b, the battery cells 30a may each be formed in, e.g., a rectangular block shape (rectangular parallelepiped shape). In an implementation, twelve battery cells 30a may be disposed in the battery case 30b to be arranged in the proximity of each other in the horizontal direction such that four battery cells 30a are arranged in the left-right direction and three battery cells 30a are arranged in the front-rear direction.

The battery case 30b may include a battery frame 40, a bottom 50, a lid 60, and the like. The battery frame 40 may include a frame member 41 and a plurality of reinforcement members 45, the frame member 41 being formed in a rectangular shape to be adjacent to and to surround a group of the battery cells 30a disposed in a dense state. Each of the frame member 41 and the reinforcement members 45 may be a hollow long member having a specific cross-sectional shape. These members may have a square pipe shape and may be formed by, e.g., extrusion molding of aluminum.

The battery frame 40 may be constituted by joining the frame member 41 and the reinforcement members 45 to each other with the wall surfaces of the frame member 41 and the wall surfaces of the reinforcement members 45 directed in the up-down direction and the left-right direction. The detailed structure of the battery unit 30, such as the frame member 41 and the reinforcement members 45, will be separately described below.

The frame member 41 may include a pair of first frame members 41a facing each other in the left-right direction, and a pair of second frame members 41b facing each other in the front-rear direction. Each second frame member 41b may have a partitioned cross section having a rectangular shape. A front fastening part 31 for fastening to the torque box 70 may be provided at or on the second frame member 41b on the front side (also referred to as “front second frame member 41b”) at, e.g., two predetermined bilaterally symmetrical positions.

Each first frame member 41a may have a partitioned cross section having an inverted L-shaped, and a support part 42 projecting outward may be integrally provided in the upper part of the first frame member 41a. A side fastening part 32 for fastening to the side sill 6 may be provided in the support part 42 at a plurality of positions spaced apart from each other in the long-length direction. In addition, screwing parts 33 for screwing the lid 60 may be provided in the frame member 41 at a plurality of positions.

The reinforcement member 45 may also have a partitioned cross section having a rectangular shape. In an implementation, three reinforcement members 45 may be provided. The respective reinforcement members 45 may extend (e.g., lengthwise) in the front-rear direction between the pair of first frame members 41a in parallel with the pair of first frame members 41a. The respective reinforcement members 45 may be between the front and rear second frame members 41b in such a way as to pass between the battery cells 30a.

Each of the bottom 50 and the lid 60 may be formed by press working on an aluminum plate material. The bottom 50 may be joined (e.g., welded) to the lower surface of the frame member 41 in such a way as to cover the lower side of the battery cells 30a. The lid 60 that covers the upper side of the battery cells 30a may be fastened to the upper surface of the frame member 41.

The lid 60 may have an external appearance having a tray shape with an opening thereof directed downward. In an implementation, the lid 60 may include an upper surface part 61, a side surface part 62, and a flange surface part 63, the upper surface part 61 having a rectangular shape as viewed from above, the side surface part 62 having a frame shape and having the upper edge thereof formed continuously with the peripheral edge of the upper surface part 61, the flange surface part 63 projecting from the lower edge of the side surface part 62 to an area around it.

A platform-shaped part 64 may be at the rear part of the lid 60, the platform-shaped part 64 extending along the rear edge of the lid 60, and having the upper surface part 61 located at a raised position. In an implementation, electric members, such as a power input/output device and a control device that controls the battery unit 30, may be housed in this platform-shaped part 64. The side surface parts 62 facing in the left-right direction may be formed to be suspended from the upper surface part 61. In an implementation, the side surface part 62 facing in the forward direction may be formed to be downwardly inclined toward the front side (also referred to as “downward inclined surface part 65”).

The flange surface part 63 may have fastening holes 66 for screwing at a plurality of positions corresponding to the arrangement of the screwing parts 33 of the frame member 41. By fastening a screw 67 inserted through each fastening hole 66 to the screwing part 33, the lid 60 may be detachably attached to the frame member 41.

By attaching the lid 60 to the frame member 41, a step part 68 may be formed at the front end part of the battery unit 30, the step part 68 having a height (e.g., as measured from the bottom 50 in the up-down or vertical direction) lower than the height of the upper surface of the battery unit 30, e.g., the upper surface part 61. In an implementation, a step-shaped part having a height lower than the height of the upper surface part 61 may be formed by the upper surface of the front second frame member 41b and the outer surface of the downward inclined surface part 65 in such a way as to extend in the left-right direction along the front edge of the battery unit 30.

In this vehicle-body structure of the vehicle, the torque boxes 70 may be received into or accommodated by this step part 68, such that the front end part of the battery unit 30 and the torque boxes 70 may overlap with each other in the up-down direction. Therefore, it is possible to form the battery unit 30 into a rectangular shape having a size substantially equal to the size of the floor panel 8 having a rectangular shape as viewed in a top plan view. It is possible to enlarge the battery unit 30 in the forward direction while ensuring the function of the torque boxes 70 and hence, it is possible to achieve the battery unit 30 having a large capacity.

### <Torque Box>

When a load acts on the vehicle from the front side due to a collision or the like, the bumper beam 2 receives the load. Most of the load received by the bumper beam 2 is transmitted rearward via the left and right crush cans 12 and the pair of front side frames 5.

The torque boxes 70 may couple the rear end parts 5b of the left and right front side frame 5 to the front end parts of the side sills 6. In an implementation, the torque boxes 70 may transmit a load that acts on the pair of front side frames 5 to the pair of side sills 6.

To appropriately transmit a load, the torque boxes 70 may satisfy predetermined strength and rigidity. In this vehicle body 1, the torque boxes 70 having a closed cross-sectional structure excellent in strength and rigidity may be formed by attaching box panels 71 having a specific shape to the lower surface of the front end part of the floor panel 8. These torque boxes 70 may couple the rear end parts 5b of the left and right front side frames 5 to the front end parts of the side sills 6 in cooperation with the floor panel 8.

The vehicle body 1 may include two box panels 71. These box panels 71 are formed in a bilaterally symmetrical shape. The left and right box panels 71, 71 are joined and attached to the lower surfaces of the left and right portions of the front end part of the floor panel 8.

Each torque box 70 may have a relatively long dimension in the left-right direction along the front end part of the floor panel 8, and may have a closed cross-sectional structure having a substantially triangular cross section with a relatively small deviation in aspect ratio as viewed from the left-right direction. Accordingly, these torque boxes 70 may be excellent in strength and rigidity.

As described above, each front side frame 5 may be joined to the upward inclined surface part 8a of the floor panel 8 and to the torque box 70 via the rear end part 5b of the front side frame 5. In an implementation, as shown in FIG. 3, FIG. 4, and FIG. 5, the rear end part 5b of each front side frame 5 may include a frame joint part that is formed in conformity with the shapes of the upward inclined surface part 8a and of the front wall of the torque box 70.

Joint flange parts 5d may be provided in the frame joint part, the joint flange parts 5d being brought into surface contact with the upward inclined surface part 8a and with the front wall of the torque box 70. By joining the joint flange parts 5d to the upward inclined surface part 8a and to the front wall of the torque box 70, each front side frame 5 may be coupled to the floor panel 8 and the torque boxes 70.

In an implementation, the respective torque boxes 70 having a closed cross-sectional structure excellent in strength and rigidity may couple the rear end parts 5b of the left and right front side frames 5 to the front end parts of the side sills 6 in cooperation with the floor panel 8. Accordingly, when a load acts on the respective front side frames 5 from the front side, it is possible to effectively transmit the load to the respective torque boxes 70. Further, it is possible to effectively transmit the load that acts on the respective torque boxes 70 to the respective side sills 6. The torque boxes 70 are allowed to sufficiently exhibit their functions.

The step part 68 may be provided at the front end part of the battery unit 30. This step part 68 may extend along the lower walls and the rear walls of the respective torque boxes 70. Therefore, the front end part of the battery unit 30 and the respective torque boxes 70 may overlap with each other in the up-down direction with a slight clearance C therebetween. Thus, the battery unit 30 may have a rectangular shape having substantially the same size as the floor panel 8 as viewed from above. As a result, the battery unit 30 may be supported by the pair of torque boxes 70 and the pair of side sills 6, which are excellent in strength and rigidity.

In an implementation, as shown in FIG. 3 and FIG. 6, a bolt support pipe 31a may be attached to each front fastening part 31, the bolt support pipe 31a penetrating through the front second frame member 41b in the up-down direction. The upper end part of the bolt support pipe 31a may protrude from the upper surface of the front second frame member 41b. A bolt 31b inserted through the bolt support pipe 31a may be fastened to a fastening seat 72 on the lower wall of each torque box 70.

In an implementation, the respective side fastening parts 32 at the support parts 42 of the first frame members 41a may be constituted in the same manner as the front fastening parts 31. In an implementation, bolts 32b inserted through bolt support pipes of the respective side fastening parts 32 may be fastened to the respective side sills 6. Thus, the lower surface of the floor panel 8, including the torque boxes 70, may face the upper surface of the battery case 30b, including the frame member 41 and the lid 60, with a predetermined gap (clearance C) therebetween.

### <Detailed Structure of Battery Unit>

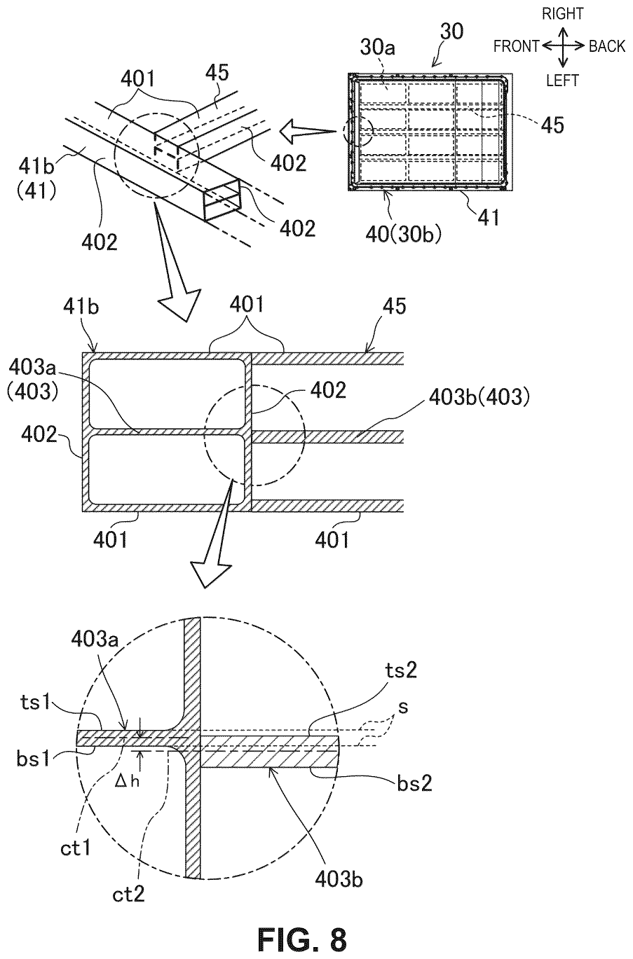

To specifically describe the disclosed technology, FIG. 8 shows a main part (a portion at which the reinforcement member 45 and the frame member 41 are coupled to each other) of the battery unit 30. In the present embodiment, a portion at which the second frame member 41b of the frame member 41 is coupled will be described as an example.

As described above, each of the frame member 41 and the reinforcement members 45 may be a hollow long member formed by, e.g., extrusion molding of aluminum, and may have a specific cross-sectional shape. In an implementation, each of the frame member 41 and the reinforcement members 45 may have the same cross-sectional shapes (the cross-sectional shape taken along the short-length direction and the cross-sectional shape taken along the long-length direction) over the entire length thereof.

Each of the frame member 41 and the reinforcement members 45 may include a pair of first wall surfaces 401 facing each other in the up-down direction, and a pair of second wall surfaces 402 extending along both edges of the pair of first wall surfaces 401 and facing each other in the front-rear direction or the left-right direction. The pair of second wall surfaces 402 of the second frame member 41b may face each other in the front-rear direction, and the pair of second wall surfaces 402 of the reinforcement member 45 face each other in the left-right direction.

The peripheral edge part of the end surface of the reinforcement member 45 may be joined (e.g., welded) to the second frame member 41b with the end surface of the reinforcement member 45 butted against the side surface of the second frame member 41b. By performing joining as described above, these components may be coupled to each other. In an implementation, the second frame member 41b and the reinforcement member 45 may be positioned in the up-down direction by adjusting (aligning) the positions of the first wall surfaces 401 of the second frame member 41b and the reinforcement member 45.

In an implementation, a vertical width (a distance between the upper surface and the lower surface) between the pair of first wall surfaces 401 of the frame member 41 may be substantially equal to that between the pair of first wall surfaces 401 of the reinforcement member 45. In an implementation, only either one surface may be aligned. The positions of the frame member 41 and the reinforcement member 45 in the up-down direction may be adjusted by recess-projection fitting or the like. A structure (positioning structure) that facilitates appropriate positioning of the frame member 41 and the reinforcement member 45 in the up-down direction may be provided between the frame member 41 and the reinforcement member 45.

A reinforcement wall part 403 may be provided in each of the frame member 41 and the reinforcement member 45, the reinforcement wall part 403 extending in parallel with the first wall surfaces 401 above and below the reinforcement wall part 403, and partitioning the inside of the member in the up-down direction (the reinforcement wall part 403 of the second frame member 41b is also referred to as “first stage reinforcement wall part 403a”, and the reinforcement wall part 403 of the reinforcement member 45 is also referred to as “second stage reinforcement wall part 403b”). Each of the first stage reinforcement wall part 403a and the second stage reinforcement wall part 403b may be disposed at a position at which a space between the first wall surfaces 401 is substantially bisected in the up-down direction.

The middle drawing in FIG. 8 shows a transverse cross-sectional shape (a cross-sectional shape as viewed from the short-length direction) of the second frame member 41b, and a longitudinal cross-sectional shape (a cross-sectional shape as viewed from the long-length direction) of the reinforcement member 45. The first stage reinforcement wall part 403a may have substantially the same thickness over the entire frame member 41, and the second stage reinforcement wall part 403b may have substantially the same thickness over the entire reinforcement member 45 (a difference being within the range of tolerance).

Based on a difference in length in a direction in which a particularly important load (a load from the front side in the present embodiment) is transmitted (the front-rear direction in the present embodiment), the thickness of the second stage reinforcement wall part 403b may be larger than the thickness of the first stage reinforcement wall part 403a. In an implementation, compared with the second frame member 41b, to which the main load is applied in the short-length direction, the reinforcement member 45, to which a load is applied in the long-length direction, may have higher strength and higher rigidity.

These reinforcement wall parts 403a, 403b may be provided mainly to reinforce the frame member 41 and the reinforcement member 45. Accordingly, to allow a load to be efficiently transmitted, the first stage reinforcement wall part 403a and the second stage reinforcement wall part 403b could be located at the same height and could be continuously formed in series. In some other battery units, such a configuration may be generally adopted.

In contrast, due to the application of the disclosed technology, the battery unit 30 may be designed such that the position of the first stage reinforcement wall part 403a and the position of the second stage reinforcement wall part 403b are intentionally slightly displaced or offset from each other in the up-down direction, as shown in FIG. 8 in an enlarged manner. In an implementation, the first stage reinforcement wall part 403a and the second stage reinforcement wall part 403b may be configured such that a thickness center ct1 of the first stage reinforcement wall part 403a and a thickness center ct2 of the second stage reinforcement wall part 403b are offset from each other in the up-down direction and, in the up-down direction, an upper surface ts2 or a lower surface bs2 of the second stage reinforcement wall part 403b may be located between an upper surface ts1 and a lower surface bs1 of the first stage reinforcement wall part 403a.

In the present embodiment, the thickness center ct1 of the first stage reinforcement wall part 403a and the thickness center ct2 of the second stage reinforcement wall part 403b may be offset from each other such that the thickness center ct1 of the first stage reinforcement wall part 403a is located at a position higher than the thickness center ct2 of the second stage reinforcement wall part 403b (indicated by “Ah” in FIG. 8). The upper surface ts2 of the second stage reinforcement wall part 403b may be located between the upper surface ts1 and the lower surface bs1 of the first stage reinforcement wall part 403a (see extending broken lines “s” and “s” in FIG. 8).

In an implementation, the lower surface bs1 of the first stage reinforcement wall part 403a may be located at a position higher than the thickness center ct2 of the second stage reinforcement wall. The offset direction may be a downward direction, and the lower surface bs2 of the second stage reinforcement wall part 403b may be located between the upper surface ts1 and the lower surface bs1 of the first stage reinforcement wall part 403a. In such a case, the upper surface ts1 of the first stage reinforcement wall part 403a may be located at a position lower than the thickness center ct2 of the second stage reinforcement wall.

Given the functions of the first stage reinforcement wall part 403a and the second stage reinforcement wall part 403b, these parts generally extend in parallel with the horizontal direction. Depending on specifications, there may be cases in which the first stage reinforcement wall part 403a and the second stage reinforcement wall part 403b are slightly bent or inclined. However, provided that the first stage reinforcement wall part 403a and the second stage reinforcement wall part 403b are provided for the purpose of reinforcement, such a difference in shape may have no impact.

As shown in the lower part in FIG. 8 in an enlarged manner, it may be sufficient to constitute the first stage reinforcement wall part 403a and the second stage reinforcement wall part 403b such that such an arrangement is adopted at least in the vicinity of a portion at which the first stage reinforcement wall part 403a and the second stage reinforcement wall part 403b are joined to each other. In an implementation, at the portion at which the first stage reinforcement wall part 403a and the second stage reinforcement wall part 403b are joined to each other, the joined end parts of the first stage reinforcement wall part 403a and the second stage reinforcement wall part 403b may be substantially parallel to each other.

In the disclosed technology, the frame member 41 and the reinforcement member 45 are intentionally constituted to always adopt such an arrangement in a stable manner. In an implementation, the positioning structure described above is one of the configurations for achieving such an arrangement.

By adopting the configuration in which the position of the frame member 41 and the position of the reinforcement member 45 are slightly displaced from each other in the up-down direction as described above, it is possible to appropriately transmit a load from the frame member 41 to the reinforcement member 45. Even in the case in which a load acts on the connecting part of the frame member 41 in a concentrated manner, it is possible to suppress interference of the frame member 41 with the battery cell 30a. Therefore, it is possible to provide a battery unit 30 that has a light weight and that has excellent performance of protecting the battery cells 30a.

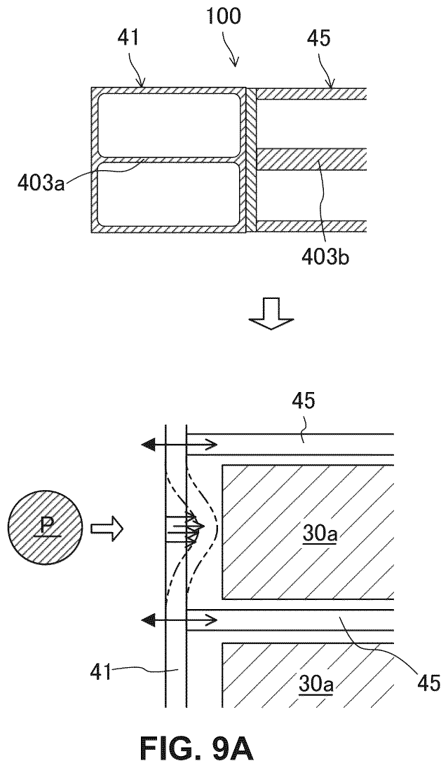

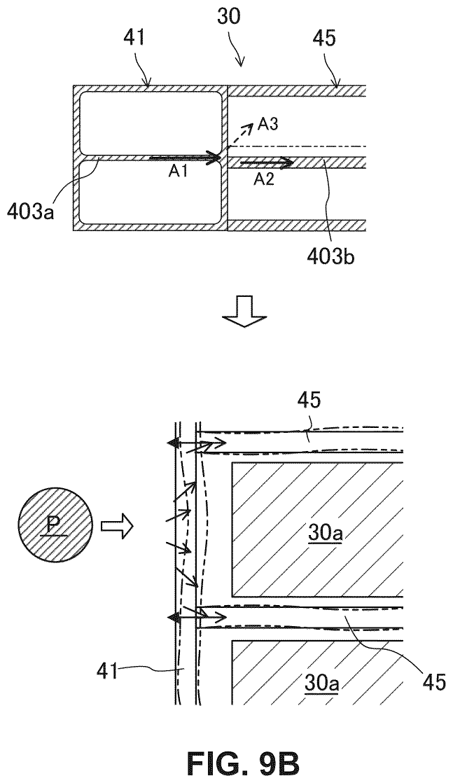

This will be described with reference to FIG. 9A and FIG. 9B. FIG. 9A shows the structure of a comparative example. FIG. 9B shows the structure of the battery unit 30 according to the present embodiment, to which the disclosed technology is applied.

The battery units 100, 30 may have a function of protecting the battery cells 30a in the battery units 100, 30 against a load that acts thereon from the outside due to a collision or the like. The frame member 41 may receive the load first. The load may then be transmitted to the reinforcement members 45. In doing so, to appropriately transmit the load with excessive deformation suppressed, the reinforcement member 45 (second stage reinforcement member), to which the load is transmitted next, may have a higher strength and rigidity (e.g., 1.2 times to 1.5 times higher) than a strength and rigidity of the frame member 41 (first stage reinforcement member), which receives the load first. For this reason, the second stage reinforcement wall part 403 may have a larger thickness than the first stage reinforcement wall part 403.

A length in a direction in which a load acts may also have an influence. When a member has a long length in the direction in which a load acts, the member may be easily deflected and deformed. When the reinforcement member 45 is deflected, there is a possibility of the reinforcement member 45 interfering with the battery cell 30a. Accordingly, the reinforcement members 45 may have a higher strength and a higher rigidity.

Particularly in the case of the battery units 100, 30, a length in the direction in which a load acts may be by far longer in the reinforcement member 45, and hence it is impossible to avoid a situation in which the second stage reinforcement wall part 403b has a large thickness. In view of the above, as shown in FIG. 9A, the comparative structure is configured such that the second stage reinforcement wall part 403b has an increased thickness to appropriately receive and transmit a load that acts thereon from the second frame member 41b.

However, as in the case of a collision with a pole P as shown in the bottom drawing in FIG. 9A, there may be cases in which a load acts on a connecting part between two adjacent reinforcement members 45, e.g., a portion that is not reinforced by the reinforcement member 45, in a pinpoint manner. In such a case, a so-called three-point bending state may be caused because both sides of the connecting part are firmly supported by the reinforcement members 45.

Thus, the load may not be appropriately transmitted to the reinforcement members 45, and may be concentrated at the portion at which the load acts. As a result, there is a possibility that the frame member 41 is significantly deformed inward, thus interfering with the battery cell 30a.

In contrast, in the battery unit 30 to which the disclosed technology is applied, as shown in FIG. 9B, the first stage reinforcement wall part 403a and the second stage reinforcement wall part 403b may be disposed in a state of being intentionally displaced from each other in the up-down direction. In an implementation, as shown in the top drawing in FIG. 9B, the first stage reinforcement wall part 403a and the second stage reinforcement wall part 403b may be offset from each other in a state of partially overlapping each other along the up-down direction.

Therefore, as shown by arrows A1 to A3 in FIG. 9B, of a load A1 that acts on the first stage reinforcement wall part 403a, a load A2 of a predetermined proportion is transmitted to the reinforcement member 45, and the remaining load A3 may be transmitted to components other than the second stage reinforcement wall part 403b via the frame member 41.

As described above, the comparative reinforcement member 45 may have a strength and rigidity 1.2 times to 1.5 times the strength and rigidity of the frame member 41, which is a source from which the load is transmitted. In contrast, in this battery unit 30, a load transmitted to the reinforcement member 45 may be reduced and hence it is also possible to reduce strength and rigidity for the reinforcement member 45. It in turn allows the thickness of the reinforcement wall part 403 to be reduced. The reinforcement member 45 may be designed to have strength and rigidity that is substantially the same (one times) as the strength and rigidity of the frame member 41. This battery unit 30 can achieve a reduction in costs of members, and a reduction in weight.

Even in the case in which a load acts on a connecting part in a pinpoint manner as shown in the bottom drawing in FIG. 9B, the reinforcement members 45 supporting both sides of the connecting part may have a supporting force that is appropriately reduced and hence a three-point bending state can be avoided by the reinforcement members 45. Therefore, it is possible to suppress a situation in which the frame member 41 is significantly deformed inward, thus interfering with the battery cell 30a.

By applying the disclosed technology, the battery unit 30 can appropriately transmit a load to the reinforcement members 45, and can alleviate concentration of the load at the portion at which the load acts. In an implementation, regardless of a portion at which a load acts, it is possible to appropriately disperse the acting load, and to transmit the acting load from the frame member 41 to the reinforcement members 45. The entire frame member 41 and the entire reinforcement members 45 may be appropriately deformed to receive the load. Accordingly, it is possible to effectively protect the battery cells 30a.

Further, this battery unit 30 can also be assembled to a portion of the transmission mechanism for transmitting a load (collision load) that acts on the vehicle body 1.

In an implementation, as described above, in the case in which a load acts on the vehicle from the front side, most of the load may be transmitted rearward via the bumper beam 2, the crush cans 12, the pair of front side frames 5, the pair of torque boxes 70, and the pair of side sills 6.

From a viewpoint of protecting the battery cells 30a, in principle it is desirable to avoid a heavy load acting on the battery unit 30. However, due to the necessity of ensuring a space for mounting a battery unit 30 having a large capacity, there may be limitations on the design of the vehicle body 1. Therefore, there is a possibility of a decrease in the strength of the vehicle body 1.

In contrast, when this battery unit 30 is adopted, even in the case in which a load acts on the connecting part, it is possible to appropriately transmit the load while protecting the battery cells 30a in the battery unit 30. Accordingly, it is possible to assemble the battery unit 30 to a portion of the collision-load transmission mechanism of the vehicle body 1. The strength of the vehicle body 1 can be complemented.

In an implementation, as shown in FIG. 3, FIG. 4 and others, the respective front side frames 5 may include, at the rear end parts 5b thereof, downward protruding parts 410 located at positions lower than the torque boxes 70. The upper part of the front second frame member 41b may be disposed at a position that overlaps with these downward protruding parts 410 along the up-down direction as viewed from the front-rear direction and the left-right direction. In an implementation, the respective downward protruding parts 410 may be disposed such that the lower ends of the respective downward protruding parts 410 are located at positions lower than the upper surface of the front second frame member 41b. The respective downward protruding parts 410 may face the front second frame member 41b in the front-rear direction with a slight gap therebetween.

When a heavy collision load acts on the pair of front side frames 5 due to a front collision or the like, the front side frames 5 may be deformed. The rear end parts 5b of the front side frames 5 may then be displaced rearward. The downward protruding parts 410 may be received by the front second frame member 41b at the time of displacement and hence a portion of the collision load can be transmitted to the battery unit 30.

The battery unit 30 can transmit the collision load to the pair of side sills 6 via the battery frame 40 together with the pair of torque boxes 70. The collision load can be transmitted in a distributed manner by the battery frame 40 and the pair of torque boxes 70, and hence it is possible to reduce a burden on the torque box 70. The battery unit 30 can complement the strength of the vehicle body 1.

In an implementation, at least a portion of the front end part of the reinforcement member 45 may be disposed at a position that overlaps with the rear end part 5b of the front side frame 5 along the left-right direction as viewed from the front-rear direction.

As described above, when the disclosed technology is applied, even in the case in which a load acts on the connecting part of the frame member 41 in a concentrated manner, it is possible to suppress interference of the frame member 41 with the battery cell 30a. Accordingly, the rear end part 5b of the front side frame 5 can be disposed at an arbitrary position on the frame member 41.

However, in the battery frame 40, portions reinforced by the reinforcement members 45 may be more excellent in strength than other portions. Accordingly, by disposing the downward protruding parts 410 at positions that at least partially overlap with the front end parts of the reinforcement members 45 along the left-right direction, it is possible to efficiently transmit the load on the front side frames 5 to the reinforcement members 45. It is possible to transmit the collision load caused by a front collision to the respective side sills 6 while effectively protecting the battery cells 30a.

### Second Embodiment

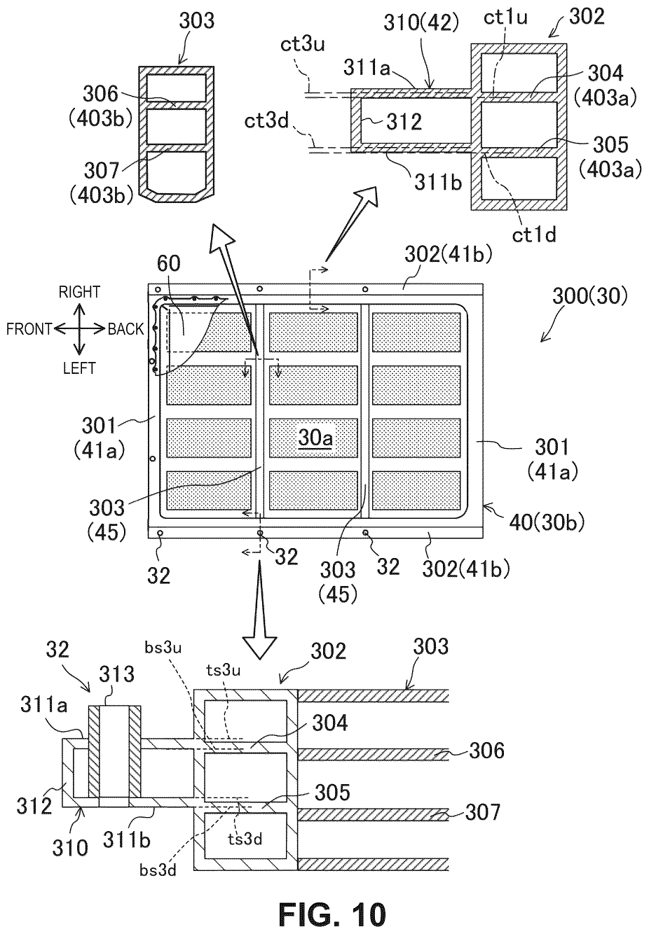

FIG. 10 shows a second embodiment of the disclosed technology as an example. This embodiment differs from the embodiment described above in the direction of reinforcement members 45 of a battery unit 30. Except for it, the basic configuration of this embodiment is substantially the same as that of the embodiment described above.

In an implementation, not only a vehicle body 1 but also battery cells 30a, a lid 60, a bottom 50, and the like of the battery unit 30 have no difference from those in the embodiment described above. Accordingly, differences will be described specifically and the description of other components will be omitted.

In the case of the battery unit 30 (also referred to as “second battery unit 300”) of the present embodiment, the reinforcement members 45 are disposed to extend in the left-right direction when the second battery unit 300 is assembled to the vehicle.

In an implementation, in the battery unit 30 described above, the frame member 41 may include the pair of first frame members 41a facing each other in the left-right direction, and the pair of second frame members 41b, 41b facing each other in the front-rear direction. In contrast, in the case of the second battery unit 300, a pair of lateral frame members 301 (corresponding to the first frame members 41a) may face each other in the front-rear direction, and a pair of longitudinal frame members 302 (corresponding to the second frame members 41b) may face each other in the left-right direction.

In the case of the second battery unit 300, two reinforcement members 45 (also referred to as “lateral reinforcement members 303”) may be provided. The respective lateral reinforcement members 303 may extend between the pair of lateral frame members 301 in the left-right direction in parallel with the pair of lateral frame members 301. The respective lateral reinforcement members 303 may be between the left and right longitudinal frame members 302 in such a way as to pass through between the battery cells 30a.

In the case of the second battery unit 300, the inside of each of the longitudinal frame members 302 and the lateral reinforcement members 303 may be partitioned into three sections. In an implementation, each longitudinal frame member 302 may include a pair of first stage reinforcement wall parts 403a (also referred to as “upper first stage reinforcement wall part 304” and “lower first stage reinforcement wall part 305”) spaced apart in the up-down direction. Each lateral reinforcement member 303 may include a pair of second stage reinforcement wall parts 403b (also referred to as “upper second stage reinforcement wall part 306” and “lower second stage reinforcement wall part 307”) spaced apart in the up-down direction.

In the same manner as the battery unit 30 described above, the upper first stage reinforcement wall part 304 and the upper second stage reinforcement wall part 306 may be offset from each other in a state of partially overlapping each other along the up-down direction, and the lower first stage reinforcement wall part 305 and the lower second stage reinforcement wall part 307 may be offset from each other in a state of partially overlapping each other along the up-down direction.

Further, in the case of the second battery unit 300, support parts 42 (also referred to as “second support parts 310”) provided at the respective longitudinal frame members 302 may be hollow and may have a rectangular cross section. In an implementation, each second support part 310 may include a pair of support wall parts 311 (an upper support wall part 311a and a lower support wall part 311b) and an end wall part 312, the pair of support wall parts 311 projecting in the horizontal direction from the side surface of the longitudinal frame member 302, and facing each other in the up-down direction, the end wall part 312 being formed continuously with the protruding ends of these support wall parts 311a, 311b.

In an implementation, the second support part 310 may be constituted by integrally forming a square pipe part with the longitudinal frame member 302.

Accordingly, it is possible to achieve a reduction in weight and achieve excellent strength and excellent rigidity.

A side fastening part 32 for fastening to a side sill 6 may be provided at three positions that correspond to the positions of the lateral frame member 301 on the front side and of the respective lateral reinforcement members 303. In an implementation, as viewed from the up-down direction or the left-right direction, the respective side fastening parts 32 may be disposed at positions that overlap with the end parts of the lateral frame member 301 on the front side and of the respective lateral reinforcement members 303 along the front-rear direction or may be disposed near those positions.

Each side fastening part 32 may be constituted of, e.g., through holes formed in the upper support wall part 311a and the lower support wall part 311b, and a second bolt support pipe 313 installed in such a way as to communicate with these through holes. Bolts inserted through the respective second bolt support pipes 313 may be fastened to the respective side sills 6. Therefore, the respective longitudinal frame members 302 may be fixed to the respective side sills 6.

A collision load caused by a side collision and acting on the side sill 6 may be transmitted to a battery frame 40 via the respective side fastening parts 32. Accordingly, this collision load can be efficiently transmitted to the lateral reinforcement members 303. It is possible to transmit a collision load caused by a side collision to the vehicle body 1 via the battery frame 40 while effectively protecting the battery cells 30a.

In an implementation, at least one of a thickness center ct3u of the upper support wall part 311a or a thickness center ct3d of the lower support wall part 311b may be offset from a thickness center ct1u of the upper first stage reinforcement wall part 304 and/or a thickness center ct1d of the lower first stage reinforcement wall part 305 in the up-down direction, and the upper surfaces or the lower surfaces of the first stage reinforcement wall parts 403a may be located between the upper surfaces and the lower surfaces of the (these) support wall parts 311 in the up-down direction.

In an implementation, as shown in FIG. 10, the thickness center ct3u of the upper support wall part 311a may be offset upward from the thickness center ct1u of the upper first stage reinforcement wall part 304, and the upper surface of the upper first stage reinforcement wall part 304 may be located between an upper surface ts3u and a lower surface bs3u of the upper support wall part 311a in the up-down direction. In the same manner, the thickness center ct3d of the lower support wall part 311b may be offset upward from the thickness center ct1d of the lower first stage reinforcement wall part 305, and the upper surface of the lower first stage reinforcement wall part 305 may be located between an upper surface ts3d and a lower surface bs3d of the lower support wall part 311b in the up-down direction.

The offset direction may be a downward direction, and a surface located between the upper and lower surfaces of the upper support wall part 311a or the like may be the lower surface of the upper first stage reinforcement wall part 304 or the like.

With such a configuration, it is possible to allow a load to be transmitted to the second support part 310, the longitudinal frame member 302, and the lateral frame member 301 in this order in three steps while the load is appropriately released. Therefore, the longitudinal frame members may not have a higher strength than the support parts and the lateral frame members may not have a still higher strength than the longitudinal frame members as in the comparative techniques, and hence it is possible to reduce the thickness of the reinforcement wall parts of the longitudinal frame members and the lateral frame members. It is possible to achieve a reduction in the weight of the battery unit without impairing performance of protecting the battery cells.

The disclosed technology is not limited to the embodiments described above, and also includes various other configurations. For example, although an electric vehicle is taken as an example of the vehicle in the embodiments, the vehicle may be a hybrid vehicle. The detailed shapes of the vehicle-body structure, including the box panels 71, and the battery units 30, 300 may be suitably changed depending on specifications provided that such a change does not affect the application of the disclosed technology. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated.

In an implementation, the number of installations of the first stage reinforcement wall parts 403a and the number of installations of the second stage reinforcement wall parts 403b may be three or more. In an implementation, the inside of the support parts 42, 310 may also be reinforced by the reinforcement wall parts 403. In an implementation, the frame members and the reinforcement members may be die cast products.

### REFERENCE SIGNS LIST

1 vehicle body
2 bumper beam
3 shroud upper member
4 apron member
5 front side frame
5a main part
5b rear end part
6 side sill
7 dash panel
8 floor panel
8 a upward inclined surface part
8b bulging part
12 crush can
30 battery unit
30a battery cell
30b battery case
40 battery frame
41 frame member
41a first frame member
41b second frame member
42 support part
45 reinforcement member
50 bottom
60 lid
65 downward inclined surface part
68 step part
70 torque box
401 first wall surface
402 second wall surface
403 reinforcement wall part
403a first stage reinforcement wall part
403b second stage reinforcement wall part
410 downward protruding part

1. A battery unit disposed below a floor panel of a vehicle with a battery cell housed in a battery case, wherein:
the battery case includes
a battery frame including a frame member and at least one reinforcement member, the frame member including a pair of first frame members facing each other and a pair of second frame members facing each other and having rectangular shape adjacent to and surrounding the battery cell, the at least one reinforcement member being between the pair of second frame members and parallel with the pair of first frame members of the frame member; and
a bottom and a lid which are assembled to the battery frame to cover an upper side and a lower side of the battery cell,
each of the frame member and the at least one reinforcement member is a hollow long member having a specific cross-sectional shape,
the battery frame is formed by joining the frame member and the at least one reinforcement member to each other with wall surfaces of the frame member and wall surfaces of the at least one reinforcement member directed in an up-down direction and a left-right direction,
each second frame member of the pair of second frame members includes a first stage reinforcement wall part that extends in parallel with wall surfaces above and below the first stage reinforcement wall part, the first stage reinforcement wall part partitioning an inside of the second frame member in the up-down direction,
the at least one reinforcement member includes a second stage reinforcement wall part that extends in parallel with wall surfaces above and below the second stage reinforcement wall part, the second stage reinforcement wall part partitioning an inside of the at least one reinforcement member in the up-down direction,
a thickness center of the first stage reinforcement wall part and a thickness center of the second stage reinforcement wall part are offset from each other in the up-down direction, and
an upper surface or a lower surface of the second stage reinforcement wall part is located between an upper surface and a lower surface of the first stage reinforcement wall part in the up-down direction.

2. The battery unit according to claim 1, wherein the battery unit is assembled to the vehicle such that the at least one reinforcement member extends in a front-rear direction.

3. The battery unit according to claim 2, wherein:
the vehicle includes a pair of front side frames that constitute a vehicle body together with the floor panel, and that extend forward from a front side of the floor panel while being spaced apart from each other in the left-right direction, and
at least a portion of the second frame member that is located on a front side is disposed at a position that overlaps with rear end parts of the pair of front side frames along the up-down direction.

4. The battery unit according to claim 3, wherein at least a portion of a front end part of the at least one reinforcement member is at a position that overlaps with a rear end part of a front side frame of the pair of front side frames along the left-right direction.

5. The battery unit according to claim 1, wherein the battery unit is assembled to the vehicle such that the at least one reinforcement member extends in the left-right direction.

6. The battery unit according to claim 5, wherein:
the vehicle includes a pair of side sills that constitute a vehicle body together with the floor panel, and that extend in a front-rear direction along left side edges and right side edges of the floor panel,
the battery frame further includes a support part that is hollow and has a rectangular cross section, the support part being integrally provided so as to project to an outer side of the frame member, and
the battery case is supported by the pair of side sills via the support part.

7. The battery unit according to claim 6, wherein:
the support part includes an upper support wall and a lower support wall that extend in parallel with the wall surfaces,
a thickness center of at least one of the upper support wall and the lower support wall is offset from the thickness center of the first stage reinforcement wall part in the up-down direction, and
the upper surface or the lower surface of the first stage reinforcement wall part is located between an upper surface and a lower surface of the upper support wall or the lower support wall in the up-down direction.

8. The battery unit according to claim 7, wherein the thickness center of at least one of the upper support wall and the lower support wall is offset from the thickness center of the second stage reinforcement wall.

9. The battery unit according to claim 7, wherein the second stage reinforcement wall part includes an upper second stage reinforcement wall part and a lower second stage reinforcement wall part spaced apart in the up-down direction.

10. The battery unit according to claim 1, wherein a thickness of the second stage reinforcement wall part is larger than a thickness of the first stage reinforcement wall part.

11. The battery unit according to claim 1, wherein the at least one reinforcement member includes a plurality of parallel reinforcement members.

12. A vehicle including the battery unit according to claim 1.
